(19) United States
(12) Patent Application Publication
(10) Pub. No.: US 2018/0190287 A1
(43) Pub. Date: Jul. 5, 2018

(54) SELECTION SYSTEM AND METHOD

(71) Applicant: Nuance Communications, Inc., Burlington, MA (US)

(72) Inventors: Slawek Jarosz, Senneville (CA); David Ardman, Cote Saint Luc (CA); Patrick Lars Langer, Neu-Ulm (DE); Lior Ben-Gigi, Hampstead (CA)

(21) Appl. No.: 15/863,235

(22) Filed: Jan. 5, 2018

Related U.S. Application Data
(63) Continuation of application No. 62/442,560, filed on Jan. 5, 2017.

(51) Int. Cl. G10L 15/22; G06F 3/16

(52) U.S. Cl. CPC G10L 15/22; G10L 2015/223; G06F 3/167

(57) ABSTRACT

A method, computer program product, and computing system for receiving a first verbal command from a user of a consumer electronics device. The first verbal command is processed to define a first possible operations list that is provided to the user. A selected operation is received from the user, wherein the selected operation is chosen from the possible operations list. A second verbal command is received from the user of the consumer electronics device, wherein the second verbal command is at least similar to the first verbal command. One or more probable operations are defined based, at least in part, upon the possible operations list and the selected operation. The one or more probable operations are provided to the user.

### RELATED APPLICATION(S)

This application claims the benefit of U.S. Provisional Application No. 62/442,560, filed on 5 Jan. 2017; the contents of which are incorporated herein by reference.

### TECHNICAL FIELD

This disclosure relates to selection systems and, more particularly, to selection systems for use with consumer electronic devices.

### BACKGROUND

Today's consumer electronic devices are often controllable via voice commands. For example, these devices may include voice-to-text technology that may convert the user's voice commands into text-based commands. Accordingly, the user may issue a voice command that may be processed by the consumer electronics device to generate a text-based command that may be mapped onto the available functionality of the consumer electronic device.

Unfortunately, the voice interfaces in these consumer electronic devices are often underwhelming. For example and when controlling these consumer electronic devices, these voice command systems seldom learn from your previous selections and preferences. Therefore and e.g., when making similar and repeated selections via the voice interface, the user may be required to repeatedly navigate the same voice-controlled menus over and over again.

### SUMMARY OF DISCLOSURE

In one implementation, a computer-implemented method is executed on a computing device and includes receiving a first verbal command from a user of a consumer electronics device. The first verbal command is processed to define a first possible operations list that is provided to the user. A selected operation is received from the user, wherein the selected operation is chosen from the possible operations list. A second verbal command is received from the user of the consumer electronics device, wherein the second verbal command is at least similar to the first verbal command. One or more probable operations are defined based, at least in part, upon the possible operations list and the selected operation. The one or more probable operations are provided to the user.

One or more of the following features may be included. Defining one or more probable operations may include reordering at least a portion of the first possible operations list to define a weighted operations list; and providing the one or more probable operations to the user may include providing the weighted operations list to the user. Defining one or more probable operations includes identifying a single high-probability operation and providing the one or more probable operations to the user may include automatically executing the single high-probability operation. A verbal response may be received concerning the automatic execution of the single high-probability operation. The verbal response may include one or more of: a cancellation response concerning the automatic execution of the single high-probability operation; and a modification response concerning the automatic execution of the single high-probability operation. The consumer electronics device may include one or more of: a vehicle infotainment system; a smart phone; and an intelligent assistant. The verbal command may include one or more of: a telephony verbal command; a navigation verbal command; a messaging verbal command; an email verbal command; and an entertainment verbal command.

In another implementation, a computer program product resides on a computer readable medium and has a plurality of instructions stored on it. When executed by a processor, the instructions cause the processor to perform operations including receiving a first verbal command from a user of a consumer electronics device. The first verbal command is processed to define a first possible operations list that is provided to the user. A selected operation is received from the user, wherein the selected operation is chosen from the possible operations list. A second verbal command is received from the user of the consumer electronics device, wherein the second verbal command is at least similar to the first verbal command. One or more probable operations are defined based, at least in part, upon the possible operations list and the selected operation. The one or more probable operations are provided to the user.

One or more of the following features may be included. Defining one or more probable operations may include reordering at least a portion of the first possible operations list to define a weighted operations list; and providing the one or more probable operations to the user may include providing the weighted operations list to the user. Defining one or more probable operations includes identifying a single high-probability operation and providing the one or more probable operations to the user may include automatically executing the single high-probability operation. A verbal response may be received concerning the automatic execution of the single high-probability operation. The verbal response may include one or more of: a cancellation response concerning the automatic execution of the single high-probability operation; and a modification response concerning the automatic execution of the single high-probability operation. The consumer electronics device may include one or more of: a vehicle infotainment system; a smart phone; and an intelligent assistant. The verbal command may include one or more of: a telephony verbal command; a navigation verbal command; a messaging verbal command; an email verbal command; and an entertainment verbal command.

In another implementation, a computing system includes a processor and memory is configured to perform operations including receiving a first verbal command from a user of a consumer electronics device. The first verbal command is processed to define a first possible operations list that is provided to the user. A selected operation is received from the user, wherein the selected operation is chosen from the possible operations list. A second verbal command is received from the user of the consumer electronics device, wherein the second verbal command is at least similar to the first verbal command. One or more probable operations are defined based, at least in part, upon the possible operations list and the selected operation. The one or more probable operations are provided to the user.

One or more of the following features may be included. Defining one or more probable operations may include reordering at least a portion of the first possible operations list to define a weighted operations list; and providing the one or more probable operations to the user may include providing the weighted operations list to the user. Defining one or more probable operations includes identifying a single high-probability operation and providing the one or more probable operations to the user may include automatically executing the single high-probability operation. A verbal response may be received concerning the automatic execution of the single high-probability operation. The verbal response may include one or more of: a cancellation response concerning the automatic execution of the single high-probability operation; and a modification response concerning the automatic execution of the single high-probability operation. The consumer electronics device may include one or more of: a vehicle infotainment system; a smart phone; and an intelligent assistant. The verbal command may include one or more of: a telephony verbal command; a navigation verbal command; a messaging verbal command; an email verbal command; and an entertainment verbal command.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a consumer electronic device that executes a system selection process according to an embodiment of the present disclosure; and

FIG. 2 is a flowchart of the system selection process of FIG. 1 according to an embodiment of the present disclosure.

Like reference symbols in the various drawings indicate like elements.

### DETAILED DESCRIPTION OF THE PREFERRED EMBODIMENTS

System Overview

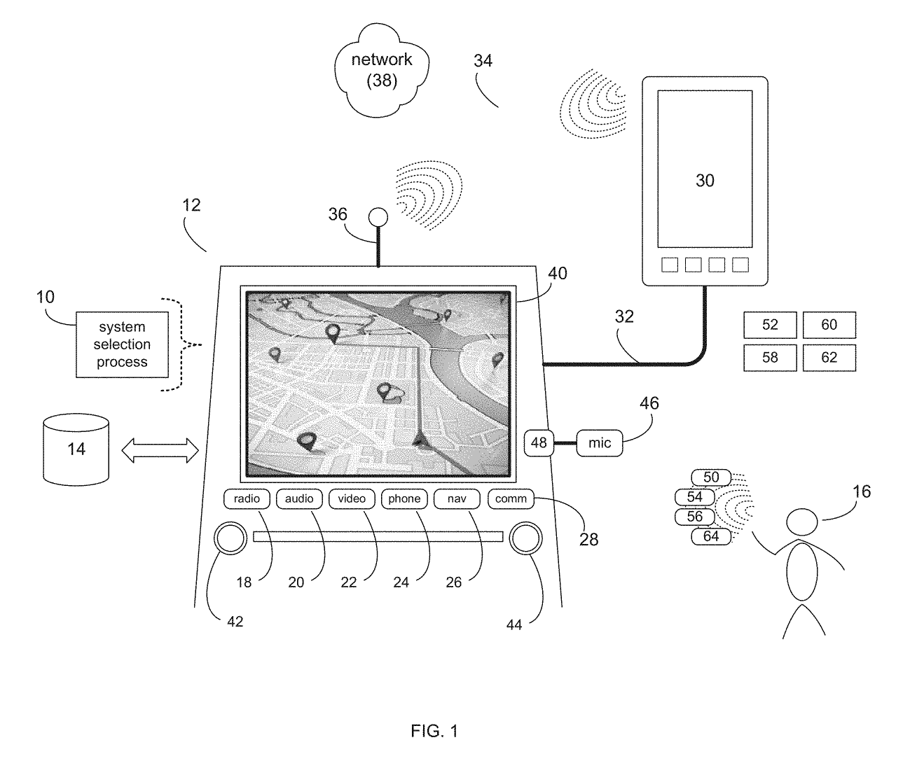

In FIG. 1, there is shown system selection process 10. System selection process 10 may reside on and may be executed by consumer electronic device 12. Examples of consumer electronic device 12 may include but are not limited to a vehicle infotainment system, a smart phone, or an intelligent assistant (e.g., an Amazon Alexa™). Examples of a vehicle infotainment system may include any of the types of infotainment systems that are incorporated into vehicles, such as vehicle navigation systems, vehicle music systems, vehicle video systems, vehicle phone systems, and vehicle climate control systems.

The instruction sets and subroutines of system selection process 10, which may be stored on storage device 14 coupled to consumer electronic device 12, may be executed by one or more processors (not shown) and one or more memory architectures (not shown) included within consumer electronic device 12. Examples of storage device 14 may include but are not limited to: a hard disk drive; a RAID device; a random access memory (RAM); a read-only memory (ROM); and all forms of flash memory storage devices. Consumer electronic device 12 may execute an operating system, examples of which may include but are not limited to Microsoft Windows™, Android™, iOS™, Linux™, or a custom operating system.

When configured as a vehicle infotainment system, consumer electronic device 12 may be configured to execute various different functionalities that may be of interest/useful to a user (e.g., user 16). Examples of such functionalities may include but are not limited to: radio functionality (e.g., that enables the playing of terrestrial radio stations and satellite radio stations); audio functionality (e.g., that enables the playing of audio, wherein this audio may be disc-based or locally stored on storage device 14); video functionality (e.g., that enables the playing of video, wherein this video may be disc-based or locally stored on storage device 14); phone functionality (e.g., that enables the placing and receiving of phone calls); navigation functionality (e.g., that enables the execution of navigation/guidance functionality); and communication functionality (e.g., that enables the sending and receiving of email/text messages/instant messages).

When configured as a vehicle infotainment system, consumer electronic device 12 may include a plurality of buttons (e.g., physical buttons or electronic buttons) that enable the selection of the above-described functionality. For example, the above-described radio functionality may be selectable via “radio” button 18; the above-described audio functionality may be selectable via “audio” button 20; the above-described video functionality may be selectable via “video” button 22; the above-described phone functionality may be selectable via “phone” button 24; the above-described navigation functionality may be selectable via “nav” button 26; and the above-described communications functionality may be selectable via “comm” button 28.

When configured as a vehicle infotainment system, consumer electronic device 12 may be configured to interface with one or more external systems (e.g., external system 30). Examples of external system 30 may include but are not limited to: a cellular telephone; a smart phone; a tablet computing device; a portable computing device; and a handheld entertainment device (e.g., such as a gaming device). When interfacing with consumer electronic device 12, external system 30 may be releasably coupled to consumer electronic device 12 via a hardwired connection (e.g., USB cable 32). Alternatively, external system 30 may be wirelessly coupled to consumer electronic device 12 via wireless communication channel 34 established between external system 30 and antenna 36 of consumer electronic device 12. An example of wireless communication channel 34 may include but is not limited to a Bluetooth communication channel. As is known in the art, Bluetooth is a telecommunications industry specification that allows e.g., mobile phones, computers, and personal digital assistants to be interconnected using a short-range wireless connection.

Consumer electronic device 12 and/or external system 30 may be configured to be wirelessly coupled to/access an external network (e.g., network 38). Examples of network 38 may include but are not limited to the internet, a cellular network, a WiFi network, and/or a cloud-based computing platform.

As discussed above, consumer electronic device 12 may be configured to execute various different functionalities that may be of interest/useful for a user (e.g., user 16). Some of these functionalities may be locally resident on (provided by) consumer electronic device 12. Additionally/alternatively, some of these functionalities may be remotely resident on (provided by) external system 30. Examples of such remotely-resident functionalities may include phone functionality (e.g., that enables the placing and receiving of phone calls via consumer electronic device 12 using external system 30) and communication functional (that enables user 16 to send/receive email, send/receive text messages and/or send/receive instant messages) via consumer electronic device 12 using external system 30. Consumer electronic device 12 may also include display screen 40 and one or more knobs/dials 42, 44 that effectuate the use of such functionalities.

Consumer electronic device 12 may include microphone assembly 46 and speech-to-text conversion system 48 (such as those available from Nuance Communications, Inc. of Burlington, Mass.). Accordingly, consumer electronic device 12 may be configured to accept verbal commands (e.g., verbal command 50) that are spoken and provided by (in this example) user 16. As will be discussed below in greater detail, these verbal commands (e.g., verbal command 50) may be configured to allow user 16 to access and control the above-described functionalities in a hands-free fashion.

Fortunately and as will be discussed below in greater detail, system selection process 10 may be configured to learn from the previous selections and preferences of user 16. Therefore and e.g., when making similar and repeated selections via verbal commands, the user may not be required to repeatedly navigate the same voice-controlled menus.

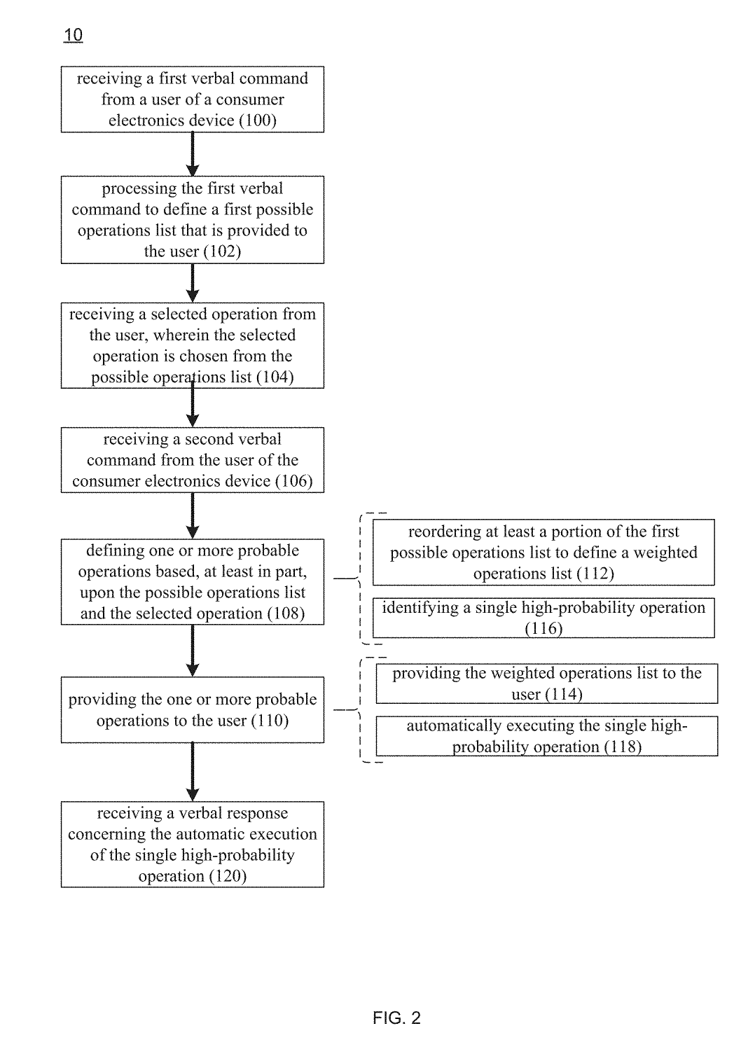

Accordingly and referring also to FIG. 2, system selection process 10 may receive 100 first verbal command 50 from user 16 of consumer electronics device 12. One example of first verbal command 50 received 100 by consumer electronic device 12 may be “Call Frank” and may concern phone functionality. Upon receiving 100 such a command, system selection process 10 may process 102 first verbal command 50 to define a first possible operations list (e.g., first possible operations list 52) that is provided to user 16.

Assume for illustrative purposes that the contact list of user 16 (which may be defined within consumer electronics device 12 or external device 30) may include several “Franks”. For example, assume that the contact list of user 16 defines a “James Frank”, a “Frank Jones”, a “Frank Miller”, and a “Frank Smith”, wherein each of these “Franks” may have multiple phone numbers defined for them.

Accordingly, system selection process 10 may define first possible operations list 52 as follows:

| | |
|---|---|
| 1 | James Frank |
| 2 | Frank Jones |
| 3 | Frank Miller |
| 4 | Frank Smith |

As first verbal command 50 (i.e., “Call Frank”) is ambiguous (due to the presence of several “Franks” within the contact list of user 16), first possible operations list 52 is shown to include multiple entries (i.e., four entries) ordered in an agnostic fashion (e.g., in alphabetical order).

While in this example, first possible operations list 52 is shown to include one entry for each name, this is for illustrative purposes only and is not intended to be a limitation of this disclosure, as other configurations are possible. For example, several entries may be defined for each “Frank” included within the contact list of user 16. Specifically, “James Frank” may include two entries (one for his mobile phone number and one for his work phone number); “Frank Jones” may include two entries (one for his home phone number and one for his work phone number); “Frank Miller” may include two entries (one for his home phone number and one for his mobile phone number), and “Frank Smith” may include three entries (one for his home phone number, one for his mobile phone number, and one for his work phone number).

Accordingly and due to the ambiguous nature of first verbal command 50 (i.e., “Call Frank”), system selection process 10 may provide first possible operations list 52 to user 16 so that user 16 may refine their command by selecting one of the (in this example) four available choices. First possible operations list 52 may be rendered by consumer electronics device 12 on display screen 40. When providing first possible operations list 52 to user 16, system selection process 10 may provide an audible command to user 16. For example, system selection process 10 “read” the entries defined within first possible operations list 52 to user 16 so that user 16 may make a selection by selecting one of (in this example) the four available choices. Alternatively, user 16 may be required to read the entries defined within first possible operations list 52 so that user 16 may make a selection by selecting one of (in this example) the four available choices.

System selection process 10 may receive 104 a selected operation (e.g., selected operation 54) from user 16, wherein selected operation 54 may be chosen from first possible operations list 52. Assume for this example that user 16 may respond by saying “Number 2”, thus generating selected operation 54 that is received 104 by system selection process 10. System selection process 10 may then effectuate phone functionality (on consumer electronic device 12 and/or external device 30) and may call Frank Jones as requested by user 16.

Assume that sometime in the future, system selection process 10 receives 106 a second verbal command (e.g., second verbal command 56) from user 16 of consumer electronics device 12, wherein second verbal command 56 is at least similar to first verbal command 50. For example, assume that sometime in the future, user 16 wishes to make another phone call to “Frank” and issues the same ambiguous verbal command, namely “Call Frank” (or something similar, such as “Please call Frank” or “Call Frank for me”).

In response to receiving 106 second verbal command 56, system selection process 10 may define 108 one or more probable operations (e.g., probable operations 58) based, at least in part, upon first possible operations list 52 and selected operation 54. For example, the last time that user 16 said “Call Frank”, system selection process 10 provided first possible operations list 52 to user 16, to which user 16 responded by saying “Number 2”, resulting in the generation of selected operation 54. Accordingly, system selection process 10 may “suspect” that user 16 again wishes to call “Frank Jones”. Accordingly, system selection process 10 may define 108 one or more probable operations 58 that are based upon (i.e., weighted) in accordance with the above-described suspicion.

When defining 108 one or more probable operations 58, system selection process 10 may reorder 112 at least a portion of first possible operations list 52 to define a weighted operations list (e.g., weighted operations list 60); wherein providing 110 one or more probable operations 58 to user 16 may include system selection process 10 providing 114 weighted operations list 60 to user 16 so that e.g., user 16 may select an entry from weighted operations list 60.

An example of such a weighted operations list (e.g., weighted operations list 60) provided 114 to user 16 by system selection process 10 may be follows:

| | |
|---|---|
| 1 | Frank Jones |
| 2 | James Frank |
| 3 | Frank Miller |
| 4 | Frank Smith |

While second verbal command 56 (i.e., “Call Frank”) is still ambiguous (due to the presence of several “Franks” within the contact list of user 16), weighted operations list 60 is ordered based, at least in part, upon first possible operations list 52 and selected operation 54. Specifically, since the first time that user 16 said “Call Frank” (i.e., in first verbal command 50) resulted in user 16 wanting to call “Frank Jones”, “Frank Jones” is now the Number 1 entry within weighted operations list 60 (as opposed to being the Number 2 entry in first possible operations list 52.

When system selection process 10 reorders 112 at least a portion of first possible operations list 52 to define a weighted operations list (e.g., weighted operations list 60), system selection process 10 may consider the time dimension (e.g. the time of the day or the day of the week). For example and when calling Frank, system selection process 10 may consider whether it is during work hours vs. after work hours vs. during the weekend

As will be discussed above in greater detail, the above-described process may be repeated until system selection process 10 is “confident” enough to automatically execute an operation that is deemed to be high-probable with respect to the functionality sought by e.g., user 16. For example, if user 16 selects the Number 1 entry within weighted operations list 60 (again resulting in user 16 wanting to call “Frank Jones”), the next time that user 16 issues the verbal command “Call Frank”. system selection process 10 may automatically call “Frank Jones”. Alternatively, system selection process 10 may require that user 16 select calling “Frank Jones” three or more times (as opposed to the two times discussed above) before system selection process 10 automatically calls “Frank Jones” in response to the verbal command “Call Frank”.

Accordingly and concerning the above-described automatic execution, when defining 108 one or more probable operations 58, system selection process 10 may identify 116 a single high-probability operation (e.g., single high-probability operation 62); wherein providing 110 one or more probable operations 58 to user 16 may include system selection process 10 automatically executing 118 single high-probability operation 62 for user 16.

Again, assume that sometime in the future, system selection process 10 receives another ambiguous verbal command (e.g., second verbal command 56 or a third or later verbal command) from user 16 of consumer electronics device 12, wherein this new verbal command is at least similar to the earlier verbal commands (e.g., first verbal command 50 and/or second verbal command 56). For example, assume that sometime in the future, user 16 wishes to make another phone call to “Frank” and issues the same ambiguous verbal command, namely “Call Frank” (or something similar, such as “Please call Frank” or “Call Frank for me”).

Accordingly and in response to receiving 106 the new ambiguous verbal command (e.g., second verbal command 56 or a third or later verbal command) from user 16, when defining 108 one or more probable operations 58, system selection process 10 may identify 116 single high-probability operation 62, that in this example is calling “Frank Jones”. Accordingly and when providing 110 one or more probable operations 58 to user 16, system selection process 10 may automatically execute 118 single high-probability operation 62 for user 16 (thus initiating calling “Frank Jones”). Accordingly, system selection process 10 may (visually or audibly) inform user 16 that they are calling “Frank Jones”.

In response to such automatic execution 118 of high-probability operation 62, user 16 may issue a verbal response (e.g., verbal response 64), wherein verbal response 64 may include one or more of: a cancellation response concerning the automatic execution of single high-probability operation 62; and a modification response concerning the automatic execution of single high-probability operation 62. For example, if the automatic execution 118 of high-probability operation 62 is incorrect, user 16 may issue e.g., a “Cancel” verbal response, or a “No . . . call Frank Miller” verbal response.

System selection process 10 may receive 120 verbal response 64 concerning automatic execution 118 of single high-probability operation 62 and may respond accordingly. For example, if verbal response 64 is clear and unambiguous (e.g., No . . . call Frank Miller”, system selection process 10 may automatically call “Frank Miller”.

If (alternatively) verbal response 64 is ambiguous (e.g., “Cancel”), system selection process 10 may request additional information by providing user 16 with an unfiltered operations list, from which user 16 may select the appropriate entry for “Frank”. An example of such an unfiltered operations list may be follows:

| | |
|---|---|
| 1 | James Frank |
| 2 | Frank Jones |
| 3 | Frank Miller |
| 4 | Frank Smith |

While the above-discussion concerned the verbal commands (e.g., first verbal command 50, second verbal command 56, and/or subsequent verbal commands) being a telephony verbal command (e.g., a command that concerns making a telephone call), this is for illustrative purposes only and is not intended to be a limitation of this disclosure, as other configurations are possible and are considered to be within the scope of this disclosure. For example, the verbal commands (e.g., first verbal command 50, second verbal command 56, and/or subsequent verbal commands) may be any type of verbal command, including but not limited to: a navigation verbal command; a messaging verbal command; an email verbal command; or an entertainment verbal command.

When a navigation verbal command, the navigation verbal commands (e.g., first verbal command 50, second verbal command 56, and/or subsequent verbal commands) may concern e.g., navigating user 16 to a certain named business or a certain named person. Accordingly, any ambiguities concerning which named business or which named person may be clarified and/or resolved in a manner similar to the way in which the above-described ambiguities concerning the person to be called were clarified.

When a messaging verbal command, the messaging verbal commands (e.g., first verbal command 50, second verbal command 56, and/or subsequent verbal commands) may concern e.g., sending a message (e.g., a text message and/or an instant message) to a certain named person. Accordingly, any ambiguities concerning which named person may be clarified and/or resolved in a manner similar to the way in which the above-described ambiguities concerning the person to be called were clarified.

When an email verbal command, the email verbal commands (e.g., first verbal command 50, second verbal command 56, and/or subsequent verbal commands) may concern e.g., sending an email to a certain named person. Accordingly, any ambiguities concerning which named person may be clarified and/or resolved in a manner similar to the way in which the above-described ambiguities concerning the person to be called were clarified.

When an entertainment verbal command, the entertainment verbal commands (e.g., first verbal command 50, second verbal command 56, and/or subsequent verbal commands) may concern e.g., playing music for user 16. Accordingly, any ambiguities concerning which music to play for user 16 may be clarified and/or resolved in a manner similar to the way in which the above-described ambiguities concerning the person to be called were clarified.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
receiving a first verbal command from a user of a consumer electronics device;
processing the first verbal command to define a first possible operations list that is provided to the user;
receiving a selected operation from the user, wherein the selected operation is chosen from the possible operations list;
receiving a second verbal command from the user of the consumer electronics device, wherein the second verbal command is at least similar to the first verbal command;
defining one or more probable operations based, at least in part, upon the possible operations list and the selected operation; and
providing the one or more probable operations to the user.

2. The computer-implemented method of claim 1 wherein:
defining one or more probable operations includes reordering at least a portion of the first possible operations list to define a weighted operations list; and
providing the one or more probable operations to the user includes providing the weighted operations list to the user.

3. The computer-implemented method of claim 1 wherein:
defining one or more probable operations includes identifying a single high-probability operation; and
providing the one or more probable operations to the user includes automatically executing the single high-probability operation.

4. The computer-implemented method of claim 3 further comprising:
receiving a verbal response concerning the automatic execution of the single high-probability operation.

5. The computer-implemented method of claim 4 wherein the verbal response includes one or more of:
a cancellation response concerning the automatic execution of the single high-probability operation; and
a modification response concerning the automatic execution of the single high-probability operation.

6. The computer-implemented method of claim 1 wherein the consumer electronics device includes one or more of:
a vehicle infotainment system;
a smart phone; and
an intelligent assistant.

7. The computer-implemented method of claim 1 wherein the verbal command includes one or more of:
a telephony verbal command;
a navigation verbal command;
a messaging verbal command;
an email verbal command; and
an entertainment verbal command.

8. A computer program product residing on a computer readable medium having a plurality of instructions stored thereon which, when executed by a processor, cause the processor to perform operations comprising:
receiving a first verbal command from a user of a consumer electronics device;
processing the first verbal command to define a first possible operations list that is provided to the user;
receiving a selected operation from the user, wherein the selected operation is chosen from the possible operations list;
receiving a second verbal command from the user of the consumer electronics device, wherein the second verbal command is at least similar to the first verbal command;
defining one or more probable operations based, at least in part, upon the possible operations list and the selected operation; and
providing the one or more probable operations to the user.

9. The computer program product of claim 8 wherein:
defining one or more probable operations includes reordering at least a portion of the first possible operations list to define a weighted operations list; and
providing the one or more probable operations to the user includes providing the weighted operations list to the user.

10. The computer program product of claim 8 wherein:
defining one or more probable operations includes identifying a single high-probability operation; and
providing the one or more probable operations to the user includes automatically executing the single high-probability operation.

11. The computer program product of claim 10 further comprising:
receiving a verbal response concerning the automatic execution of the single high-probability operation.

12. The computer program product of claim 11 wherein the verbal response includes one or more of:
a cancellation response concerning the automatic execution of the single high-probability operation; and
a modification response concerning the automatic execution of the single high-probability operation.

13. The computer program product of claim 8 wherein the consumer electronics device includes one or more of:
a vehicle infotainment system;
a smart phone; and
an intelligent assistant.

14. The computer program product of claim 8 wherein the verbal command includes one or more of:
a telephony verbal command;
a navigation verbal command;
a messaging verbal command;
an email verbal command; and
an entertainment verbal command.

15. A computing system including a processor and memory configured to perform operations comprising:
receiving a first verbal command from a user of a consumer electronics device;
processing the first verbal command to define a first possible operations list that is provided to the user;
receiving a selected operation from the user, wherein the selected operation is chosen from the possible operations list;
receiving a second verbal command from the user of the consumer electronics device, wherein the second verbal command is at least similar to the first verbal command;
defining one or more probable operations based, at least in part, upon the possible operations list and the selected operation; and
providing the one or more probable operations to the user.

16. The computing system of claim 15 wherein:
defining one or more probable operations includes reordering at least a portion of the first possible operations list to define a weighted operations list; and
providing the one or more probable operations to the user includes providing the weighted operations list to the user.

17. The computing system of claim 15 wherein:
defining one or more probable operations includes identifying a single high-probability operation; and
providing the one or more probable operations to the user includes automatically executing the single high-probability operation.

18. The computing system of claim 17 further comprising:
receiving a verbal response concerning the automatic execution of the single high-probability operation.

19. The computing system of claim 18 wherein the verbal response includes one or more of:
a cancellation response concerning the automatic execution of the single high-probability operation; and
a modification response concerning the automatic execution of the single high-probability operation.

20. The computing system of claim 15 wherein the consumer electronics device includes one or more of:
a vehicle infotainment system;
a smart phone; and
an intelligent assistant.

21. The computing system of claim 15 wherein the verbal command includes one or more of:
a telephony verbal command;
a navigation verbal command;
a messaging verbal command;
an email verbal command; and
an entertainment verbal command.
